(19) United States
(12) Patent Application Publication
(10) Pub. No.: US 2014/0280557 A1
(43) Pub. Date: Sep. 18, 2014

(54) HIGH RELIABILITY ALERT DELIVERY USING WEB-BASED INTERFACES

(71) Applicant: SAFERAGING, INC., Reston, VA (US)

(72) Inventors: John McKINLEY, Great Falls, VA (US); Christopher WILLIAMS, Herndon, VA (US)

(21) Appl. No.: 13/840,228

(22) Filed: Mar. 15, 2013

(51) Int. Cl. H04L 12/26

(52) U.S. Cl. CPC H04L 43/04
USPC 709/204

(57) ABSTRACT

A system and method for improving reliability of alert delivery using web-based interfaces are provided. A web-based rendering of an alert is created based at least in part on a detected event, and a tracking mechanism can be inserted into the web-based rendering of the alert. The web-based rendering of the alert is delivered to a device at a monitoring station. Whether the web-based rendering of the alert is rendered by the device is detected based at least in part on determining whether a request relating to the tracking mechanism is received. If not, another rendering of the alert can be delivered to another device.

### CROSS-REFERENCE TO RELATED APPLICATIONS

This application relates to co-pending U.S. patent application Ser. No. ______, entitled “MULTIPLE-RADIO PENDANTS IN EMERGENCY ASSISTANCE SYSTEMS,” filed Mar. 15, 2013, co-pending U.S. patent application Ser. No. ______, entitled “AUTOMATED EVENT SEVERITY DETERMINATION IN AN EMERGENCY ASSISTANCE SYSTEM,” filed Mar. 15, 2013, co-pending U.S. patent application Ser. No. ______, entitled “DYNAMIC PROVISIONING OF PENDANT LOGIC IN EMERGENCY ASSISTANCE SYSTEMS,” filed Mar. 15, 2013, and co-pending U.S. patent application Ser. No. ______, entitled “EVENT DETECTION AND REPORTING USING A GENERAL PURPOSE PROCESSOR AND A HARDENED PROCESSOR,” filed Mar. 15, 2013, all of which are assigned to the assignee hereof, and the entireties of which are herein incorporated by reference for all purposes.

### BACKGROUND

Alert detection systems typically include a plurality of event detecting devices located in a building, and a mechanism for communicating detected events to a remotely-located centralized station for processing of the events and subsequent remediation. The event detecting devices can communicate to an event detecting system within the building, which can access the centralized station via a remote connection therewith. Upon detecting an event, the event detecting device can alert the event detecting system, which can transmit relevant alert information to the centralized station. The information is interpreted at the centralized station, and assistance is provided where deemed necessary based on the information. In emergency assistance systems with wearable pendants, detection of a button activation on the pendant causes the pendant to transmit an alert to the event detecting system, which forwards the alert along with other relevant information (e.g., location of the event detecting system) to the centralized station. Someone at the centralized station receives the alert, and can perform one or more actions in response to the alert, such as dispatch emergency services to the location where the event detecting system is installed, communicate with a person via a microphone and speaker installed within the building (e.g., and connected to the event detecting system), and/or notify on-site care personnel of the alert (e.g., where the building is an assisted-living or other care management facility).

As computer technology and capability advances, additional mechanisms for communicating detected alerts and related information have been developed. In one case, Internet-based alerting is possible where the event detecting system communicates with the centralized station over an Internet connection to deliver events thereto. Similarly, subsequent alerting from the centralized station to on-site care personnel can be via Internet connection therebetween. Web-based interfaces are integrated as well to allow presentation of the alerts and related information as a webpage on a device for viewing by the on-site care personnel (e.g., a device at a monitoring station), a device at the centralized station of the alert detection system, etc. Some of these technologies, while providing robust and user-friendly communication of alerts however, are inherently not as reliable as may be desired for some systems, such as emergency assistance systems.

### SUMMARY

The following presents a simplified summary of one or more aspects to provide a basic understanding thereof. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that follows.

Aspects described herein relate to providing high reliability alert delivery using web-based interfaces. For example, one or more types of alert delivery confirmation can be provided to an entity communicating an alert (and/or related information). This can include confirming that the alert was rendered, confirming that the alert was viewed by someone at the receiving station, and/or the like. In addition, one or more levels of contingent alert delivery can be provided as well when delivery confirmation is not received to improve reliability of using certain mechanisms to render the alerts. This can include contingent alert delivery using a similar mechanism as for the previous alert delivery or a separate more reliable backup mechanism where confirmation is not received. In both cases, reliability of alert delivery is increased, which can be desirable in at least some alert detection systems, such as emergency assistance systems.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations may denote like elements, and in which:

FIG. 1 is an aspect of an example alert detection system for processing events and rendering related alerts.

FIG. 2 is an aspect of an example system for contingent delivery of alerts.

FIG. 3 is an aspect of an example message flow for delivering alerts and receiving confirmation of alert delivery.

FIG. 4 is an aspect of an example message flow for contingent delivery of alerts in an alert detection system.

FIG. 5 is an aspect of an example methodology for contingent delivery of alerts to different monitoring station components.

FIG. 6 is an aspect of an example methodology for providing reliable delivery of alerts to web-based interfaces and/or a telephone.

FIG. 7 is an aspect of an example system in accordance with aspects described herein.

FIG. 8 is an aspect of an example communication environment in accordance with aspects described herein.

### DETAILED DESCRIPTION

Reference will now be made in detail to various aspects, one or more examples of which are illustrated in the accompanying drawings. Each example is provided by way of explanation, and not limitation of the aspects. In fact, it will be apparent to those skilled in the art that modifications and variations can be made in the described aspects without departing from the scope or spirit thereof. For instance, features illustrated or described as part of one example may be used on another example to yield a still further example. Thus, it is intended that the described aspects cover such modifications and variations as come within the scope of the appended claims and their equivalents.

Described herein are various aspects relating to improving reliability of alert delivery in systems using web-based interfaces. High reliability of alert delivery can be desirable in certain systems, such as emergency assistance or similar systems where alerts relate to a person's wellbeing. In this regard, additional logic is provided around web-based interfaces in such systems to facilitate alert delivery confirmation, contingent alert delivery attempts using multiple delivering mechanisms, and/or the like. Alert delivery can be considered successful, for example, where alert delivery confirmation is provided or otherwise inferred for at least one of the contingent delivery attempts.

In an example, a component of the alert delivery system can provide alert delivery confirmation based at least in part on determining whether an interface for the alert (e.g., a web-based interface) is rendered by an application displaying the interface. In another example, a component of the alert delivery system can provide alert delivery confirmation based at least in part on determining whether a person is situated such to observe the alert via the interface. Moreover, in an example, the alert delivery confirmation can be based on receiving an actual confirmation by specifying receipt via the web-based interface. Contingent alert delivery can include attempting different modalities of delivering an alert where an alert delivery confirmation is not received for a prior alert delivery attempt. Using alert delivery confirmation and/or contingent alert delivery can provide a more reliable mechanism for presenting alerts using web-based interfaces.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Artificial intelligence based systems (e.g., explicitly and/or implicitly trained classifiers) can be employed in connection with performing inference and/or probabilistic determinations and/or statistical-based determinations in accordance with one or more aspects of the subject matter as described hereinafter. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for generating higher-level events from a set of events and/or data. Such inference results in the construction of new events or actions from a set of observed events or stored event data, regardless of whether the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, etc.), for example, can be employed in connection with performing automatic and/or inferred actions in connection with the subject matter.

Furthermore, the subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it is to be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the subject matter.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

FIG. 1 illustrates an example system 100 for processing events in an alert detection system. System 100 includes an event processing component 102 for receiving, processing, and/or reporting events received from one or more event detecting devices (not shown). Event processing component 102 optionally includes an event data aggregating component 104 for obtaining event data from one or more event detecting devices, or a rules processing component 106 for applying one or more rules to the event data to determine further actions to perform based on the event data. Event processing component 102 also includes an alerting component 108 for rendering one or more alerts over a network 110 based at least in part on the event data. System 100 also includes monitoring component 1 112, monitoring component 2 114, monitoring component N 116, and/or additional monitoring components to which alerting component 108 can attempt to render the one or more alerts. Monitoring components are also referred to herein as monitoring station components, monitoring devices, monitoring station devices, or similar terms, though these terms are intended to encompass substantially any devices that are capable of receiving and rendering alerts and/or related information by at least one of displaying the alerts, playing audio related to the alerts, and/or the like.

According to an example, alerting component 108 can communicate an alert to monitoring component 1 112 and await a delivery confirmation for the alert. The alert can be based on event data obtained by event data aggregating component 104 and processed by rules processing component 106 to indicate provisioning of an alert. Where the delivery confirmation is not received from monitoring component 1 112 (e.g., after a specified period of time, before detection of a specified event, etc.), alerting component 108 can communicate the alert to monitoring component 2 114, and so on. Where alerting component 108 receives an alert delivery confirmation with respect to one of the monitoring components 112, 114, or 116, alerting component 108 can refrain from attempting delivery of the alert to other monitoring components and/or can indicate delivery of the alert. The alert delivery confirmation, for example, can indicate that the alert has been rendered, that the alert has been viewed, and/or an explicit indication of receipt from the party receiving the alert. It is to be appreciated that alerting component 108 can initiate alerting sessions with at least some of the monitoring components 112, 114, or 116, in one example, such to identify delivery confirmations therefrom. For example, initiating alerting sessions can include generating context information to be included in communications between alerting component 108 and the associated monitoring component to facilitate identification of one another and/or certain parameters related to the session when communicating.

In an example, monitoring component 1 112 can include a web-based interface for rendering alerts such that failed delivery (or lack of an indication of successful delivery) can cause delivery attempts to other components in an effort to increase reliability of event delivery for web-based interfaces. For example, a tracking mechanism can be used in delivering the alert to monitoring component 1 112 to determine whether monitoring component 1 112 renders the alert. If the tracking mechanism does not indicate such rendering within a threshold period of time or before detection of a subsequent event, for example, alerting component 108 can deliver the alert (or another alert created based on the alert) to monitoring component 2 114, which may or may not use a web-based interface, and so on, until alerting component 108 receives an alert delivery confirmation or otherwise delivers the alert to all specified monitoring components.

For example, one or more of monitoring components 112, 114, or 116 can include a web-based interface (e.g., on a computer, tablet, phone, etc.) for rendering alerts, as described, an interface for receiving a text message (e.g., short message service (SMS) message) regarding the alert, a phone for receiving a phone call regarding the alert, which can require a button push for delivery confirmation, and/or the like. Moreover, network 104 can include a collection of nodes communicatively coupled with one another via one or more components (e.g., switches, routers, bridges, gateways, etc.), which can include, or can include access to, an Internet, intranet, etc. In addition, in an example, event processing component 102, and event aggregating component 104, rules processing component 106, and alerting component 108, can each be or collectively include one or more servers purposed with performing at least a portion of the described functionalities.

For example, network 110 can include a collection of nodes communicatively coupled with one another via one or more components (e.g., switches, routers, bridges, gateways, etc.), which can include, or can include access to, an Internet, intranet, etc. In addition, in an example, event processing component 102, event data aggregating component 104, rules processing component 106, and alerting component 108 can each be, or can collectively include, one or more servers purposed with performing at least a portion of the described functionalities. Thus, in one example, one or more of the components 102, 104, 106, or 108 can be distributed among multiple servers within network 104 in a cloud computing environment.

In one specific example, monitoring components 112, 114, and 116 can correlate to an assisted living facility that utilizes event detecting devices such as wearable pendants for various patients, wall-mounted devices, passive activity sensors, and/or the like. For example, wearable pendants can include various form factors, such as a pendant with a lanyard for wearing around the neck, a watch form factor for wearing on a wrist (e.g., where the watch can function as a watch and also include the pendant or components thereof), etc. Event processing center 102 can be remotely located from the assisted living facility, however. In addition, in one example, monitoring components 112, 114, and 116 (and/or the event detecting devices) can communicate with event processing component 102, alerting component 108, etc., using an event detecting system (not shown) that facilitates access over network 110. The wearable pendants can detect button pushes for assistance, falls by patients wearing the pendants, etc., and can communicate event information to event processing component 102. Similarly, other devices and sensors can communicate detected event information to event processing component 102. In either case, the communication between the pendants, devices, sensors, etc. and event processing component 102 can occur directly (e.g., over a wired or wireless connection between the pendants, devices, sensors, etc. and one or more components of the network 110), via an intermediate wired or wireless connection between the pendants, devices sensors, etc. and an on-site event detecting system, and/or the like. Event data aggregating component 104 can receive and collect such event data, and rules processing component 106 can determine to push an alert related to the event. Alerting component 108 can transmit the event to monitoring component 1 112 via network 110, which can be a web-based interface at a monitoring station in the assisted-living facility. Thus, confirming rendering of the alert to alerting component 108 can assist in verifying that someone actually viewed the alert. In other examples, viewing confirmation information can also be provided by the monitoring component 1 112 to alerting component 108.

FIG. 2 illustrates an example system 200 for delivering alerts to one or more devices at one or more monitoring stations. System 200 includes an alerting component 108 for transmitting one or more alerts to one or more monitoring station components, such as monitoring station computer 202, monitoring station device 2 204, and/or monitoring station 2 computer 206. As described, alerting component 108 can be remotely located from the monitoring station components 202, 204, and 206, and can communicate therewith over one or more networks. Alerting component 108 can include an alerting session component 208 for initiating an alerting session with one or more monitoring station components, where such session initiation is possible, an alert generating component 210 for creating one or more alerts based on event detection information, and a tracking injecting component 212 for including one or more tracking mechanisms in the one or more alerts. Alerting component 108 also includes a contingent delivery component 214 for attempting one or more alert deliveries to one or more monitoring station components, and a delivery confirming component 216 for obtaining confirmation of delivering the one or more alerts. Delivery confirming component 216 optionally includes a rendering confirming component 218 for obtaining a confirmation that the one or more alerts were rendered on the one or more monitoring station components, and/or a viewing confirming component 220 for obtaining information indicating that the one or more alerts were viewed on the one or more monitoring station components.

According to an example, alerting session component 208 can initiate an alerting session with at least monitoring station computer 202. This can include assigning a unique identifier to the monitoring station computer 202, or otherwise exchanging a unique identifier therewith, to facilitate identifying alert delivery confirmations from the monitoring station computer 202. Monitoring station computer 202 can include at least a browser 222 to render alerts on a web-based interface, such as a webpage, and can optionally include a camera 224 or other device to confirm presence of a user when alerts are rendered via browser 222. Thus, monitoring station component 202 can be substantially any browser-capable device including, but not limited to, personal computers, tablets, cellular phones, etc. Moreover, monitoring station computers 202 and/or 206, device 2 204, and/or the like can be mobile devices as well, and not necessarily restricted to being located at a fixed monitoring station. Alerting session component 208 can additionally initiate alerting sessions with one or more of monitoring station device 2 204, which can be another device at the monitoring station where monitoring station computer 202 resides, and/or monitoring station 2 computer 206, which can be a monitoring station computer, similar to computer 202, at another monitoring station. It is to be appreciated that additional or alternative monitoring stations and/or related devices can be present in system 200 as well, and alerting session component 208 can initiate alerting sessions therewith where possible.

Alert generating component 210 can create an alert for one or more events detected by event detecting devices (not shown), as described (e.g., for delivering the alert to one or more devices for remediation relating to the one or more events). The alert can include instructions for rendering on a web-based interface, such as a webpage on a web browser. As described, the alert can relate to a system where web-based alert delivery is used, and high reliability in alert delivery is desired. Thus, tracking injecting component 212 can incorporate a tracking mechanism in the alert to allow for detecting whether the alert is rendered on the web-based interface. For example, the tracking mechanism can include a command to generate a request to alerting component 108, or a related component, upon rendering the alert on the web-based interface. In this regard, rendering confirming component 218 can subsequently detect the request from the device rendering the web-based interface, and determine that the alert was rendered on the web-based interface.

Contingent delivery component 214 can deliver the alert to a monitoring station component, such as monitoring station computer 202. Contingent delivery component 214 can include logic for transmitting alerts to various devices in a contingency-based scenario. Thus, if alert delivery confirmation is not received for one device, the alert (or an alternatively-formatted representation of the alert) can be provided to another device and/or monitoring station to facilitate improved reliability of alerting. In one example, contingent delivery component 214 can be configured with a set of rules indicative of the contingent alerting, such as an ordered list of the monitoring components to which to render the alert, tracking mechanisms to use for each alert, actions indicative alert delivery confirmation for each alert, and/or similar information that allows for both the contingent delivery component 214 to deliver the alert and the delivery confirming component 216 to detect whether the alert has been rendered or otherwise received. Where the delivery confirming component 216 determines the alert is not received, contingent delivery component 214 can transmit the alert, or a representation thereof, to the next monitoring component until the alert is received or until the list is exhausted.

Delivery confirming component 216 can confirm delivery of the alert by detecting certain information. For example, rendering confirming component 218 can obtain information indicating that the alert is rendered. This can include detecting the request from the web-based interface related to the tracking mechanism, as described, determining push of a button on a telephone call for a telephone based alert, detecting a push of a button on the web-based interface, and/or the like. In another example, viewing confirming component 220 can obtain information that the alert has been viewed. In one example, this can include obtaining a picture from a camera on the monitoring component, obtaining a facial detection or recognition result from the monitoring component, obtaining input from a weight sensor on a seat at the monitor station near the monitoring component, and/or the like. The viewing confirming component 220 can obtain such information as related to a time period during which the alert is rendered at the monitoring component (e.g., based on a time period during which contingent delivery component 214 sent the alert to the monitoring component, a time period during which the monitoring station performed a request indicating that the rendering occurred, etc.). In one example, one or both of information regarding the rendering and information regarding the viewing can be considered in determining whether the alert is successfully delivered.

In a specific example, alerting session component 208 can establish an alerting session with one or more of monitoring station computer 202, monitoring station device 2 204, monitoring station 2 computer 206 and/or other devices. Alerting session component 208 can establish the alerting sessions based at least in part on determining that the contingent delivery component 214 is configured with contingent delivery rules relating to these devices 202, 204, and 206. Alert generating component 210 can generate an alert related to one or more detected events. For example, in an emergency assistance system, the one or more detected events can relate to events rendered by a wearable pendant or mounted device, a passive activity sensor, etc., such as a button pushed by a patient wearing the pendant, a detected fall, and/or the like. In any case, another component (e.g., a rules processing component 106) can trigger an alert for the event by engaging alerting component 108 as described. The alert can include information regarding the type of event, a location of the event, and/or the like.

In this example, alert generating component 210 can create the alert for rendering by a web-based interface (e.g., on the browser 222 of monitoring station computer 202). In one example, the alert can be generated as a webpage or a portion thereof, such as a hypertext markup language (HTML) webpage or a script that results in rendering of an HTML webpage, etc. Tracking injecting component 212 can include a tracking mechanism in the alert, such as an image tag for a tracking graphics interchange format (GIF) file resident on the alerting component 108 or other component of the alert detection system. For example, a tracking GIF can include a small file (e.g., a 1×1 pixel image). Tracking injecting component 212 includes an image tag for the tracking GIF in the generated web-based interface such that rendering thereof (e.g., as a webpage) causes request for the tacking GIF based on the image tag. Thus, the component storing the tracking GIF can detect the request as an indication that the interface, and accordingly the alert, were rendered. In one example, the tracking GIF can include the unique identifier from the alerting session or another identifier, and the identifier can be detected as part of the request to determine which tracking GIF was requested, and thus which alert was rendered.

Contingent delivery component 214 can transmit the web-based interface rendering of the alert, including the tracking mechanism, to monitoring station computer 202 (e.g., as a message in the alerting session established therewith). Monitoring station computer 202 receives the web-based interface rendering in the alerting session and attempts to render the web-based interface rendering on the browser 222. If the browser 222 is able to render the web-based interface, it can request the tracking GIF as part of rendering, and rendering confirming component 218 can detect the request as an indication that the alert was rendered by monitoring station computer 202. In this example, rendering confirming component 218 can notify contingent delivery component 214 that the alert was rendered, and contingent delivery component 214 can accordingly refrain from performing further contingent alert delivery logic.

In another example, tracking injecting component 212 can include a manual confirmation window with the alert for delivering to the monitoring station component 202. In this example, the manual confirmation window can require an explicit confirmation of receipt by an operator at monitoring station component 202 (e.g., via a button click, verbal confirmation, and/or the like). Monitoring station component 202 can detect the confirmation receipt event and can communicate confirmation to alerting component 108 for receipt by delivering confirming component 216, and rendering confirming component 218 can report delivery of the alert based at least in part on the event.

Where rendering confirming component 218 does not report delivery of the alert within a specified period of time or before occurrence of an event (e.g., and/or reports that the alert was not rendered), contingent delivery component 214 can attempt another method of delivering the alert, or at least a representation thereof, to monitoring station device 2 204. In one example, this device 204 can be a telephone at the monitoring station. Contingent delivery component 214 can leverage a calling system (not shown) to place a call to the telephone with a voice message indicating information related to the alert (e.g., information similar to the original alert, such as type of alert, location, etc.). The call can have an associated alert delivery confirmation in the form of a button push on the phone, and the voice message can so indicate a request that the button be pushed as a confirmation of receiving the alert. In this example, rendering confirming component 218 can detect pushing of the button during the call (e.g., within a specified time period during the call and/or before the call is terminated), which can be received as an event from the call system.

Similarly, if the button push is detected by rendering confirming component 218, it can indicate such as an alert delivery confirmation to contingent delivery component 214, which can refrain from performing further contingent delivery logic. Where rendering confirming component 218 does not report delivery confirmation for the alert within a specified period of time or before occurrence of an event (e.g., and/or reports that the alert was not rendered), contingent delivery component 214 can attempt another method of delivering the alert, or at least a representation thereof, to monitoring station 2 computer 206, and so on until an alert delivery confirmation is received, or until the list of monitoring components is exhausted. In one example, a contingent delivery can also include rendering the alert on a monitoring computer at a centralized station, which can require manual confirmation of receiving the alert, as described. If such confirmation is not received within a specified time period, additional actions can be taken, such as dispatching emergency services to the location, a reboot of one or more of the monitoring station computers or devices 202, 204, 206, etc., which can be dispatched from the centralized station, and/or the like.

Moreover, in this example, monitoring station computer 202 can include a camera 224 to detect whether a rendered alert was actually viewed by someone situated at monitoring station computer 202. Camera 224 can thus take a photo during rendering of the alert. In one example, alert generating component 210 can include a command to take the photo in the alert and/or contingent delivery component 214 can request that the photo be taken in transmitting the alert to monitoring station computer 202. In any case, camera 224 can take the photo (and/or video for a specified period of time) and transmit the photo, a facial detection or recognition result, and/or the like, to alerting component 108 or another specified server. In any case, viewing confirming component 220 can receive the photo information from the monitoring station computer 202 to determine whether the alert was viewed based on the photo information (e.g., where a face was detected during a period of time when the alert was rendered on the web-based interface). This can be an additional or alternative consideration in determining a confirmation of alert delivery at monitoring station computer 202, in one example.

FIG. 3 illustrates an example message flow 300 between a monitoring station component 302 and an alerting component 108. Alerting component 108 and monitoring station component 302 can be configured to communicate over one or more networks, as described, and alerting component 108 can communicate alerts to monitoring station component 302. Alerting component 108 and monitoring station component 302 can initiate an alerting session 306 by communicating one or more messages. Alerting component 108 can assign an identifier to monitoring station component 302 as part of this process. Alerting component 108 can generate an alert 308. This can be based on detected event information received from one or more event detecting devices, as described. Alerting component 108 can communicate an alert payload including a tracking mechanism 310 to monitoring station component 302 based on the alert. Monitoring station component 302 can generate and transmit a request based on the tracking mechanism 312 to alerting component 108. As described, this can be part of rendering the alert (e.g., on a web-based interface). Alerting component 108 can indicate delivery confirmation 314 for the alert, and thus alerting component 108 can refrain from processing further contingent alert delivery logic. Additionally, in one example, monitoring station component 302 can provide alert viewing information 316 to alerting component 108, such as a camera photo or facial detection/recognition information. In this example, alerting component 318 can optionally also indicate alert viewing confirmation, which can additionally or alternatively cause alerting component 108 to refrain from further contingent alert delivery processing.

FIG. 4 illustrates an example message flow 400 between a monitoring station component 302, alternate monitoring station component 402, and an alerting component 108. Alerting component 108 and monitoring station component 302 can initiate an alerting session 306 by communicating one or more messages. Similarly (e.g., where alternate monitoring station component 402 includes a web-based interface for rendering alerts), alerting component 108 can initiate an alerting session 404 with alternate monitoring station component 402. Alerting component 108 can assign an identifier to monitoring station component 302 and/or alternate monitoring station component 402, as part of this process. Alerting component 108 can generate an alert 308. This can be based on detected event information received from one or more event detecting devices, as described. Alerting component 108 can communicate an alert payload including a tracking mechanism 310 to monitoring station component 302 based on the alert. Alerting component can determine delivery not confirmed 406 based at least in part on detecting that an alert delivery confirmation is not received after a specified time period and/or occurrence of an event following transmitting the alert payload 310. Accordingly, alerting component 108 can instantiate contingent alert delivery logic to deliver alert 408 to alternate monitoring station component 402. This can be an alert payload with tracking mechanism, or a differently formatted representation of the alert (e.g., a phone call with corresponding voice message), etc. based on a type of alternate monitoring station component 402. Alerting component 108 can indicate delivery confirmation 410 for the alert, and thus alerting component 108 can refrain from processing further contingent alert delivery logic. The delivery confirmation 410 can be based at least in part on receiving a request related to a tracking mechanism, a button push on a telephone, a button push on a web-based interface, etc.

Referring to FIGS. 5 and 6, methodologies that can be utilized in accordance with various aspects described herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

FIG. 5 illustrates an example methodology 500 for contingent alert delivery. At 502, a rendering of an alert is created based at least in part on a detected event. The rendering can correspond to a rendering for a web-based interface (e.g., a webpage or script to generate a webpage). Moreover, the detected event can include one or more events detected by one or more event detecting devices (e.g., in an alert detection system, such as an emergency assistance system). At 504, a tracking mechanism can be inserted into the rendering of the alert. This can include, for example, including a request for a resource in the rendering such that when a receiving device renders the alert, the request is generated and can be detected for indicating alert delivery confirmation. At 506, the rendering of the alert is delivered to a device at a monitoring station. As described, the monitoring station can relate to a station at an assisted living facility or other location where an alert detection system is installed such to obtain alerts and provide remediation for the alerts. The device can display the rendering of the alert.

At 508, it can be determined whether a delivery confirmation is detected. For example, a possible delivery confirmation can relate to the alert delivery such that receiving confirmation can indicate the alert was delivered, whether rendered and/or viewed as described herein. Thus, in one example, the delivery confirmation, if received, can be a request related to the tracking mechanism, viewing confirmation information (e.g., a photo or related facial detection/recognition data), and/or the like. In addition, determining whether the delivery confirmation is detected at 508 can be based at least in part on a specified time period following delivering the alert at 506 and/or detecting an event occurrence before detecting delivery confirmation.

If delivery confirmation is not detected at 508, it can be determined at 510 whether there are more monitoring devices to receive the alert. This can include accessing a list of monitoring devices configured for alert delivery to determine whether any of the devices have not received the alert. If there are more monitoring devices at 510, the alert can be reformatted for the next monitoring device, if necessary, at 512. The alert (e.g., as reformatted) can be delivered to the next monitoring device at 514, and the method continues to step 508 to determine if a delivery confirmation for the alert is detected from the next monitoring device.

FIG. 6 illustrates an example methodology 600 for contingent alert delivery for web-based interfaces. At 602, a webpage of an alert is created based at least in part on a detected event. This can include creating a webpage or at least a portion thereof to render the alert. At 604, a tracking GIF can be inserted into the webpage. This can include inserting an image tag to request rendering of the tracking GIF on the webpage. At 606, the webpage is delivered to a device at a monitoring station. For example, an alerting session can have been initiated with the device, over which the webpage can be delivered. At 608, it can be determined whether a request for a tracking GIF is received. As described, a request for the tracking GIF can be transmitted as part of rendering the alert webpage. If the request is received, then confirmed delivery can be indicated at 614. This can occur to a component implementing contingent alert delivery logic, as described, and/or to an interface that tracks whether alerts are properly delivered.

If the request for tracking GIF is not received at 608 (e.g., within a specified time period or before receiving a specified event), a phone can be called to notify of the alert at 610. The phone can be present at the monitoring station, in one example, and the phone call can broadcast a voice message if the phone is picked up at the monitoring station. The voice message an indicate details of the alert (e.g., event type, location, etc.). The voice message can also request a button pushed on the phone to indicate successful alert delivery. At 612, it can be determined whether the requested button is pushed. If so, confirmed alert delivery can be indicated at 614. If not, the method can end. It is to be appreciated that additional alert deliveries can be used in other examples where the requested button is not pushed at 612 (e.g., within a specified period of time or before the call is terminated). Moreover, for example, where the method ends, this can result in other functionality to render the alert to someone (e.g., rendering the alert on a screen at a centralized station of an alert detection system so that someone can attempt to remedy the event causing the alarm).

To provide a context for the various aspects of the disclosed subject matter, FIGS. 7 and 8 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, tablet, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 7, an exemplary environment 700 for implementing various aspects disclosed herein includes a computer 712 (e.g., desktop, laptop, server, hand held, programmable consumer or industrial electronics . . . ). The computer 712 includes a processing unit 714, a system memory 716 and a system bus 718. The system bus 718 couples system components including, but not limited to, the system memory 716 to the processing unit 714. The processing unit 714 can be any of various available microprocessors. It is to be appreciated that dual microprocessors, multi-core and other multiprocessor architectures can be employed as the processing unit 714.

The system memory 716 includes volatile and nonvolatile memory. The basic input/output system (BIOS), containing the basic routines to transfer information between elements within the computer 712, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 712 also includes removable/non-removable, volatile/non-volatile computer storage media. FIG. 7 illustrates, for example, mass storage 724. Mass storage 724 includes, but is not limited to, devices like a magnetic or optical disk drive, floppy disk drive, flash memory or memory stick. In addition, mass storage 724 can include storage media separately or in combination with other storage media.

FIG. 7 provides software application(s) 728 that act as an intermediary between users and/or other computers and the basic computer resources described in suitable operating environment 700. Such software application(s) 728 include one or both of system and application software. System software can include an operating system, which can be stored on mass storage 724, that acts to control and allocate resources of the computer system 712. Application software takes advantage of the management of resources by system software through program modules and data stored on either or both of system memory 716 and mass storage 724.

The computer 712 also includes one or more interface components 726 that are communicatively coupled to the bus 718 and facilitate interaction with the computer 712. By way of example, the interface component 726 can be a port (e.g., serial, parallel, PCMCIA, USB, FireWire . . . ) or an interface card (e.g., sound, video, network . . . ) or the like. The interface component 726 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 712 to output device(s) via interface component 726. Output devices can include displays (e.g., cathode ray tube (CRT), liquid crystal display (LCD), light emitting diode (LCD), plasma . . . ), speakers, printers and other computers, among other things.

According to an example, computer 712 can perform the alert delivery functions of the alerting component 108, alert rendering functions of one or more monitoring components, etc., as described. In this example, the processing unit(s) 714 can comprise or receive instructions related to generating or rendering alerts, determining whether alert delivery confirmations are received, performing contingent alert deliveries, and/or other aspects described herein. It is to be appreciated that the system memory 716 can additionally or alternatively store such instructions and the processing unit(s) 714 can be utilized to process the instructions.

FIG. 8 is a schematic block diagram of a sample-computing environment 800 with which the subject innovation can interact. The environment 800 includes one or more client(s) 810. The client(s) 810 can be hardware and/or software (e.g., threads, processes, computing devices). The environment 800 also includes one or more server(s) 830. Thus, environment 800 can correspond to a two-tier client server model or a multi-tier model (e.g., client, middle tier server, data server), amongst other models. The server(s) 830 can also be hardware and/or software (e.g., threads, processes, computing devices). The servers 830 can house threads to perform transformations by employing the aspects of the subject innovation, for example. One possible communication between a client 810 and a server 830 may be in the form of a data packet transmitted between two or more computer processes.

The environment 800 includes a communication framework 850 that can be employed to facilitate communications between the client(s) 810 and the server(s) 830. Here, the client(s) 810 can correspond to program application components and the server(s) 830 can provide the functionality of the interface and optionally the storage system, as previously described. The client(s) 810 are operatively connected to one or more client data store(s) 860 that can be employed to store information local to the client(s) 810. Similarly, the server(s) 830 are operatively connected to one or more server data store(s) 840 that can be employed to store information local to the servers 830.

By way of example, one or more clients 810 can include monitoring station components, and server(s) 830 can include one or more components of an alert detection system (e.g., an alert delivering component 108), which can communicate via communication framework 850. The server(s) 830 can, in one example, generate a rendering of an alert, and can transmit such back to the client(s) 810 via communication framework 850. The client(s) 810 can request a tracking GIF in the rendering, as described, and server(s) 830 can use the request as an indication of alert delivery confirmation.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise random access memory (RAM), read-only memory (ROM), electrically erasable programmable ROM (EEPROM), compact disc (CD)-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While one or more aspects have been described above, it should be understood that any and all equivalent realizations of the presented aspects are included within the scope and spirit thereof. The aspects depicted are presented by way of example only and are not intended as limitations upon the various aspects that can be implemented in view of the descriptions. Thus, it should be understood by those of ordinary skill in this art that the presented subject matter is not limited to these aspects since modifications can be made. Therefore, it is contemplated that any and all such embodiments are included in the presented subject matter as may fall within the scope and spirit thereof.

What is claimed is:

1. A system for improving reliability of alert delivery using web-based interfaces, comprising:
an alert generating component for creating an alert based at least in part on event information of one or more events received from an event detecting device;
a tracking injecting component for modifying the alert to include a tracking mechanism for tracking whether the alert is rendered on a web-based interface of a device at a monitoring station;
a contingent delivery component for attempting delivery of the alert to the web-based interface of the device; and
a delivery confirming component for detecting whether the alert is rendered on the web-based interface of the device based at least in part on the tracking mechanism,
wherein the contingent delivery component is configured to attempt delivery of the alert, or a representation of the alert, to another device where the delivery confirming component detects that the alert is not rendered on the web-based interface of the device.

2. The system of claim 1, wherein the delivery confirming component detects whether the alert is rendered based at least in part on determining whether a request is received from the web-based interface of the device within a period of time or prior to occurrence of an event.

3. The system of claim 2, wherein the tracking mechanism comprises a tracking graphics interchange format (GIF) file, and the delivery confirming component determines whether the request is received based on determining whether a request to render the tracking GIF file is received from the web-based interface.

4. The system of claim 3, wherein the tracking GIF comprises a unique identifier assigned to the device during initiation of an alerting session with the device, and the delivery confirming component determines that the request to render the tracking GIF file is received from the device based at least in part on the unique identifier in the tracking GIF.

5. The system of claim 1, wherein the another device comprises a telephone, the contingent delivery component initiates a call to the telephone, and the delivery confirming component detects whether the alert, or the representation of the alert, is received via the call based at least in part on whether a button push on the telephone is received within a specified time period or before the call is terminated.

6. The system of claim 1, wherein the delivery confirming component is configured to detect whether the alert, or a representation of the alert, is rendered on the another device, and the contingent delivery component is configured to attempt delivery of the alert, the representation of the alert, or a different representation of the alert, to a different device where the delivery confirming component detects that the alert, or the representation of the alert, is not rendered by the another device.

7. The system of claim 1, wherein the delivery confirming component comprises a viewing confirming component for detecting whether the alert is viewed on the web-based interface of the device, and the contingent delivery component is configured to attempt delivery of the alert, or the representation of the alert, to the another device where the viewing confirming component detects that the alert is not viewed on the web-based interface of the device.

8. The system of claim 7, wherein the viewing confirming component is configured to detect whether the alert is viewed based at least in part on receiving one or more parameters from a camera at the device related to a time period when the alert is rendered on the web-based interface of the device.

9. The system of claim 8, wherein the viewing confirming component is configured to perform facial detection or recognition based at least in part on the one or more parameters received from the camera at the device to detect whether the alert is viewed on the web-based interface of the device.

10. The system of claim 1, further comprising an alerting session component for initiating an alerting session with the device, wherein the alert generating component includes one or more parameters of the alerting session in the alert, and the delivery confirming component associates a request received relating to the tracking mechanism with the device based at least in part on obtaining the one or more parameters of the alerting session from the request.

11. A method for improving reliability of alert delivery using web-based interfaces, comprising:
creating a web-based rendering of an alert based at least in part on a detected event;
inserting a tracking mechanism into the web-based rendering of the alert;
delivering the web-based rendering of the alert to a device at a monitoring station;
detecting whether the web-based rendering of the alert is rendered by the device based at least in part on determining whether a request relating to the tracking mechanism is received; and
delivering another rendering of the alert to another device where the request relating to the tracking mechanism is not received within a specified period of time or before a specified event.

12. The method of claim 11, wherein the tracking mechanism comprises a tracking graphics interchange format (GIF) file.

13. The method of claim 12, wherein the tracking GIF comprises a unique identifier assigned to the device during initiation of an alerting session with the device, and detecting whether the web-based rendering of the alert is render comprises determining that the request to render the tracking GIF file is received from the device based at least in part on the unique identifier in the tracking GIF.

14. The method of claim 11, further comprising:
detecting whether the another rendering of the alert is rendered by the another device; and
delivering a different rendering of the alert to a different device where the another rendering of the alert is not rendered by the another device within a specified period of time or before a specified event occurs.

15. The method of claim 11, further comprising detecting whether the alert is viewed on the device based at least in part on receiving viewing confirmation information, wherein the delivering another rendering of the alert occurs where the alert is not viewed on the device.

16. The method of claim 15, wherein the viewing confirmation information comprises a photo taken at the device, a facial detection based on the photo taken at the device, or a facial recognition based on the photo taken at the device.

17. The method of claim 11, further comprising detecting whether a button push on a telephone is received within a specified time period or before a call is terminated, wherein the another device comprises the telephone, and delivering the another rendering of the alert comprises initiating the call to the telephone.

18. The method of claim 11, further comprising initiating an alerting session with the device, wherein the delivering the web-based rendering of the alert occurs as part of the alerting session.

19. A computer-readable storage medium comprising computer-executable instructions that, when executed by a processor, cause the processor to:
create an alert based at least in part on event information of one or more events received from an event detecting device;
modify the alert to include a tracking mechanism for tracking whether the alert is rendered on a web-based interface of a device at a monitoring station;
attempt a delivery of the alert to the web-based interface of the device;
detect whether the alert is rendered on the web-based interface of the device based at least in part on the tracking mechanism; and
attempt another delivery of the alert, or a representation of the alert, to another device where it is detected that the alert is not rendered on the web-based interface of the device.

20. The computer-readable storage medium of claim 19, wherein the computer-executable instructions cause the processor to detect whether the alert is rendered based at least in part on determining whether a request is received from the web-based interface of the device within a period of time or prior to occurrence of an event.
